(19) United States
(12) Patent Application Publication
(10) Pub. No.: US 2024/0356175 A1
(43) Pub. Date: Oct. 24, 2024

(54) ELECTRODE ASSEMBLY, BATTERY AND ELECTRONIC DEVICE

(71) Applicant: Ningde Amperex Technology Limited, Ningde (CN)

(72) Inventor: Dongyang YAN, Ningde (CN)

(73) Assignee: Ningde Amperex Technology Limited, Ningde (CN)

(21) Appl. No.: 18/763,540

(22) Filed: Jul. 3, 2024

Related U.S. Application Data
(63) Continuation of application No. PCT/CN2022/070166, filed on Jan. 4, 2022.

(51) Int. Cl. H01M 50/536; H01M 10/04; H01M 50/119; H01M 50/533; H01M 50/534; H01M 50/578

(52) U.S. Cl. CPC H01M 50/536; H01M 10/0431; H01M 50/119; H01M 50/533; H01M 50/534; H01M 50/578; H01M 2200/20

(57) ABSTRACT

An electrode assembly includes a first conductive portion, a second conductive portion and a first metal portion. The first conductive portion includes a first region provided with a conductive material layer and a second region separated from the first region; the first metal portion is welded with the second region, and the first metal portion has a third region where a weld mark is formed; when being observed in a first direction perpendicular to a first surface of the first conductive portion, the second region has a first end and a second end; the third region has a third end and a fourth end; the first metal portion has a fifth end in a second direction, and a sixth end disposed on an opposite side of the fifth end in the second direction and closer to the second end than the fifth end.

### CROSS-REFERENCE TO RELATED APPLICATION

This application is a continuation of International Patent Application No. PCT/CN2022/070166, filed on Jan. 4, 2022, the disclosure of which is hereby incorporated by reference in its entirety.

### TECHNICAL FIELD

This application relates to the technical field of electrochemical devices, and in particular, to an electrode assembly, a battery and an electric device.

### BACKGROUND

Because of characteristics of high energy density, multiple cycling times, long storage time, etc., lithium ion batteries are widely applied to electronic equipment, such as battery vehicles, electric vehicles, intelligent storage equipment and unmanned aerial vehicles.

In a related technology, when a battery is stored at a high temperature and after the battery is excessively used, due to aggravation of a chemical side reaction inside the battery, more gas will be generated inside the battery, resulting in an adverse impact on product performance, etc. of the battery due to excessively high internal gas pressure.

### SUMMARY

An objective of embodiments of this application is to provide an electrode assembly, a battery and an electronic device to reduce the probability of thermal failure of the battery and improve product performance of the battery.

A first aspect of this application provides an electrode assembly. The electrode assembly includes a first conductive portion, a second conductive portion and a first metal portion. The first conductive portion includes a first region provided with a conductive material layer and a second region separated from the first region; the first metal portion is connected with the second region in a welded manner, and the first metal portion is provided with a third region where a weld mark is formed; when being observed in a first direction perpendicular to a first surface of the first conductive portion, the second region is provided with a first end in a second direction perpendicular to the first direction and extending from the first region to the second region, and a second end disposed on an opposite side of the first end in the second direction and farther from the conductive material layer than the first end; the third region is provided with a third end in the second direction, and a fourth end disposed on an opposite side of the third end in the second direction and closer to the second end than the third end; the first metal portion is provided with a fifth end in the second direction, and a sixth end disposed on an opposite side of the fifth end in the second direction and closer to the second end than the fifth end; and in the second direction, a first distance between the third end and the fifth end is not equal to a second distance between the fourth end and the sixth end.

In the electrode assembly provided by an embodiment of this application, the first metal portion may be connected with the first conductive portion in a welded manner, and the third region is provided at a weld position of the first metal portion and the first conductive portion and internally provided with the weld mark. In the second direction, there is the first distance between the third end of the third region and the fifth end of the first metal portion, there is the second distance between the fourth end of the third region and the sixth end of the first metal portion, and the first distance is not equal to the second distance, so that after the first metal portion is welded on the first conductive portion, welding residual stress is dispersed on the side of the fifth end and the side of the sixth end of the first metal portion at different speeds, and the welding residual stress tends to be concentrated on a side of the third region closer to the first metal portion. Therefore, when internal heat of a battery is relatively high, side reactions between an electrolyte and a positive or negative electrode may increase, which in turn generates more gas, leading to an increase in internal gas pressure. The relatively high gas pressure can impact and disconnect the side of the third region closer to the first metal portion, thereby disconnecting the first metal portion from the first conductive portion and realizing an open circuit of the battery, which is conducive to reducing the probability of thermal failure of the battery, and improving the life and safety of the battery.

In addition, the electrode assembly according to the embodiment of this application can further have the following additional technical features.

In some embodiments of this application, the first distance is greater than the second distance. In this way, a side of the first metal portion close to the sixth end tends to be impacted by the relatively high gas pressure inside the battery and disconnected from the first conductive portion, thereby realizing the open circuit of the battery and further improving the product performance of the battery.

In some embodiments of this application, the first distance is less than the second distance. In this way, a side of the first metal portion close to the fifth end tends to be impacted by the relatively high gas pressure inside the battery and disconnected from the first conductive portion, thereby realizing the open circuit of the battery and further improving the product performance of the battery.

In some embodiments of this application, the first metal portion is provided with a seventh end separated from the second region in a third direction perpendicular to the second direction, and an eighth end disposed on an opposite side of the seventh end in the third direction; when being observed in the first direction, the third region includes a ninth end in the third direction, and a tenth end disposed on an opposite side of the ninth end in the third direction and closer to the eighth end than the ninth end; and in the third direction, a third distance between the ninth end and the seventh end is not equal to a fourth distance between the tenth end and the eighth end.

In the third direction, the third region provided with the weld mark is also not located in a middle of the first metal portion, so that after the first metal portion is welded on the first conductive portion, the welding residual stress is also dispersed on the side of the seventh end and the side of the eighth end of the first metal portion at different speeds. The relatively high gas pressure inside the battery can impact and disconnect the side of the third region closer to the first metal portion in the second direction and the side of the third region closer to the first metal portion in the third direction, thereby disconnecting the first metal portion from the first conductive portion, realizing the open circuit of the battery, and further improving the product performance of the battery.

Further, the third distance is greater than the fourth distance. In this way, in the third direction, the relatively high gas pressure inside the battery tends to impact and disconnect a side of the first metal portion close to the eighth end from the first conductive portion.

Alternatively, in some other embodiments of this application, the third distance is less than the fourth distance. In this way, in the third direction, the relatively high gas pressure inside the battery tends to impact and disconnect a side of the first metal portion close to the seventh end from the first conductive portion, thereby realizing the open circuit of the battery and further improving the product performance of the battery.

In some embodiments of this application, the second conductive portion includes a fourth region provided with a conductive material layer and a fifth region separated from the fourth region; the electrode assembly further includes a second metal portion, the second metal portion being connected with the fifth region in a welded manner, and the second metal portion including a sixth region provided with a weld mark; when being observed in the first direction perpendicular to a second surface of the second conductive portion, the fifth region is provided with a first side in the second direction, and a second side disposed on an opposite side of the first side in the second direction and farther from the conductive material layer than the first side; the sixth region is provided with a third side in the second direction, and a fourth side disposed on an opposite side of the third side in the second direction and closer to the second side than the third side; the second metal portion is provided with a fifth side in the second direction, and a sixth side disposed on an opposite side of the fifth side in the second direction and closer to the second side than the fifth side; and in the second direction, a fifth distance between the third side and the fifth side is not equal to a sixth distance between the fourth side and the sixth side.

The electrode assembly provided by the embodiment of this application further includes a second conductive portion and a second metal portion. The second metal portion is welded to the second conductive portion, and a sixth region is provided at a weld position of the second metal portion and the second conductive portion and internally provided with a weld mark. When the internal heat of the battery is relatively high, the side reactions between the electrolyte and the positive or negative electrode may increase, which in turn generates more gas, leading to the increase in internal gas pressure. The relatively high gas pressure tends to impact and disconnect a side of the sixth region closer to the second metal portion, thereby disconnecting the second metal portion from the second conductive portion and realizing the open circuit of the battery, which is conducive to reducing the probability of thermal failure of the battery, and improving the product performance of the battery.

In some embodiments of this application, the fifth distance is greater than the sixth distance. In this way, the relatively high gas pressure inside the battery can impact and disconnect a side of the second metal portion close to the sixth side from the second conductive portion, thereby realizing the open circuit of the battery and further improving the product performance of the battery.

In some embodiments of this application, the fifth distance is less than the sixth distance. In this way, the relatively high gas pressure inside the battery can impact and disconnect a side of the second metal portion close to the fifth side from the second conductive portion, thereby realizing the open circuit of the battery and further improving the product performance of the battery.

In some embodiments of this application, the second metal portion is provided with a seventh side separated from the fifth region in a third direction perpendicular to the second direction, and an eighth side disposed on an opposite side of the seventh side in the third direction; when being observed in the first direction, the sixth region is provided with a ninth side in the third direction, and a tenth side disposed on an opposite side of the ninth side in the third direction and closer to the eighth side than the ninth side; and in the third direction, a seventh distance between the ninth side and the seventh side is not equal to an eighth distance between the tenth side and the eighth side.

In the third direction, the sixth region provided with the weld mark is also not located in a middle of the second metal portion, so that after the second metal portion is welded on the second conductive portion, welding residual stress is also dispersed on the seventh side and the eighth side of the second metal portion at different speeds. The relatively high gas pressure inside the battery can impact and disconnect the side of the sixth region closer to the second metal portion in the second direction and the side of the sixth region closer to the second metal portion in the third direction, thereby disconnecting the second metal portion from the second conductive portion.

Further, the seventh distance is greater than the eighth distance. In this way, in the third direction, the relatively high gas pressure inside the battery tends to impact and disconnect a side of the second metal portion close to the eighth side from the second conductive portion, thereby realizing the open circuit of the battery and further improving the product performance of the battery.

Alternatively, in some other embodiments of this application, the seventh distance is less than the eighth distance. In this way, in the third direction, the relatively high gas pressure inside the battery tends to impact and disconnect a side of the second metal portion close to the seventh side from the second conductive portion, thereby realizing the open circuit of the battery and further improving the product performance of the battery.

In some embodiments of this application, in the second direction, a ninth distance between the first end and the fifth end is greater than a tenth distance between the second end and the sixth end. In the second direction, the first metal portion is not located in a middle of the second region. In this way, the relatively high gas pressure inside the battery tends to impact and disconnect a side of the first metal portion close to the second end from the first conductive portion, thereby realizing the open circuit of the battery and further improving the product performance of the battery.

In some embodiments of this application, in the second direction, a distance between the first end and the fifth end ranges from 1 mm to 30 mm, and a distance between the second end and the sixth end ranges from 1 mm to 20 mm. In this way, the first metal portion is at a certain distance from both the first end and the second end of the first conductive portion, which is conducive to avoiding the impact on the first metal portion when the first conductive portion is manufactured.

In some embodiments of this application, in the second direction, an eleventh distance between the first side and the fifth side is less than a twelfth distance between the second side and the sixth side. In this way, the welding residual stress on the second metal portion tends to be concentrated on a side of the second metal portion close to the first side. The relatively high gas pressure inside the battery tends to impact and disconnect the side of the second metal portion close to the first side from the second conductive portion, thereby realizing the open circuit of the battery and further improving the product performance of the battery.

In some embodiments of this application, in the second direction, a distance between the first side and the fifth side ranges from 1 mm to 30 mm, and a distance between the second side and the sixth side ranges from 1 mm to 20 mm. In this way, the second metal portion is at a certain distance from both the first side and the second side of the second conductive portion, which is conducive to avoiding the impact on the second metal portion when the second conductive portion is manufactured.

In some embodiments of this application, in the second direction, a distance between the first end and the second end ranges from 10 mm to 40 mm; and a distance between the first side and the second side ranges from 10 mm to 40 mm. In this way, both the second region and the fifth region have enough space to accommodate the first metal portion and the second metal portion, so as to reserve more welding space for the first metal portion and the second metal portion.

In some embodiments of this application, the first conductive portion further includes a seventh region separated from the first region, and the seventh region is located on a side of the first region away from the second region. In this way, the first metal portion can be not only selectively welded to the second region, but also selectively welded to the seventh region, so that the first metal portion can be located at different positions of the first conductive portion, which is conducive to improving diversity of the electrode assembly.

In some embodiments of this application, the second conductive portion further includes an eighth region separated from the fourth region, and the eighth region is located on a side of the fourth region away from the fifth region. In this way, the second metal portion can be not only selectively welded to the fifth region, but also selectively welded to the eighth region, so that the second metal portion can be located at different positions of the second conductive portion, which is conducive to improving the diversity of the electrode assembly.

In some embodiments of this application, the first conductive portion serves as a positive electrode. The first metal portion is connected with the positive electrode to serve as a positive electrode tab.

In some embodiments of this application, the second conductive portion serves as a negative electrode. The second metal portion is connected with the negative electrode to serve as a negative electrode tab.

In some embodiments of this application, the first conductive portion is wound around a first axis and includes a plurality of layers of first regions in the first direction, the second conductive portion is wound around the first axis and includes a plurality of layers of fourth regions in the first direction, the first metal portion is connected with an outermost first region in the first direction, and/or the second metal portion is connected with an outermost fourth region in the first direction. In this way, both the first metal portion and the second metal portion are located on an outermost side of the electrode assembly, and the pressure on the outermost side is greater than the pressure on other parts of the electrode assembly, which is conducive to disconnecting the first metal portion from the first conductive portion or disconnecting the second metal portion from the second conductive portion.

A second aspect of this application provides a battery. The battery includes a housing and the above-mentioned electrode assembly, and the electrode assembly is placed in the housing.

According to the battery provided by an embodiment of this application, by improving the electrode assembly in the battery, the product performance of the battery is advantageously improved. The electrode assembly includes the first conductive portion, the second conductive portion and the first metal portion. The first metal portion of the electrode assembly is connected with the first conductive portion in the welded manner, and the third region is provided at the weld position of the first metal portion and the first conductive portion and internally provided with the weld mark. In the second direction, there is the first distance between the third end of the third region and the fifth end of the first metal portion, there is the second distance between the fourth end of the third region and the sixth end of the first metal portion, and the first distance is not equal to the second distance. Therefore, after the first metal portion is welded on the first conductive portion, the welding residual stress is dispersed on the side of the fifth end and the side of the sixth end of the first metal portion at different speeds, and the welding residual stress tends to be concentrated on the side of the third region closer to the first metal portion. Therefore, when the internal heat of the battery is relatively high, the side reactions between the electrolyte and the positive or negative electrode may increase, which in turn generates more gas, leading to the increase in internal gas pressure. The relatively high gas pressure can impact and disconnect the side of the third region closer to the first metal portion, thereby disconnecting the first metal portion from the first conductive portion and realizing the open circuit of the battery, which is conducive to reducing the probability of thermal failure of the battery, and improving the product performance of the battery.

In addition, the battery according to the embodiment of this application can further have the following additional technical features.

In some embodiments of this application, a material of the housing includes metal. The housing of the metal material facilitates protection of the internal electrode assembly, which is conducive to improving reliability of the battery.

In some embodiments of this application, the battery is a wound battery.

A third aspect of this application provides an electronic device. The electronic device includes the above-mentioned battery.

In the electronic device provided by an embodiment of this application, by improving the electrode assembly of the battery in the electronic device, the product performance of the electronic device is advantageously improved. The electrode assembly of the electronic device includes the first conductive portion, the second conductive portion and the first metal portion. The first metal portion of the electrode assembly is welded to the first conductive portion, and the third region is provided at the weld position of the first metal portion and the first conductive portion and internally provided with the weld mark. In the direction from the first region to the second region, there is the first distance between the third end of the third region and the fifth end of the first metal portion, there is the second distance between the fourth end of the third region and the sixth end of the first metal portion, and the first distance is not equal to the second distance. In other words, in the direction from the first region to the second region, the third region provided with the weld mark is not located in the middle of the first metal portion, that is, the weld mark is not located in the middle of the first metal portion. Therefore, after the first metal portion is welded on the first conductive portion, the welding residual stress is dispersed on the side of the fifth end and the side of the sixth end of the first metal portion at different speeds, and the welding residual stress tends to be concentrated on the side of the third region closer to the first metal portion. Therefore, when the internal heat of the battery is relatively high, the side reactions between the electrolyte and the positive or negative electrode may increase, which in turn generates more gas, leading to the increase in internal gas pressure. The relatively high gas pressure can impact and disconnect the side of the third region closer to the first metal portion, thereby disconnecting the first metal portion from the first conductive portion and realizing the open circuit of the battery, which is conducive to reducing the probability of thermal failure of the battery, and then improving the product performance of the electronic device.

### BRIEF DESCRIPTION OF DRAWINGS

In order to more clearly illustrate technical solutions of embodiments of this application and the prior art, the following will briefly introduce the drawings that are desired to be used in the embodiments and the prior art. Obviously, the drawings in the following description are merely some embodiments of this application, from which other embodiments may be obtained by those of ordinary skill in the art without creative labor.

FIG. 1 is a schematic structural diagram of a wound electrode assembly in an embodiment of this application.

FIG. 2 is a schematic structural diagram of a third region or a sixth region according to an embodiment of this application.

FIG. 3 is a schematic structural diagram of a first conductive portion after expansion according to an embodiment of this application.

FIG. 4 is a schematic enlarged diagram of an M region in FIG. 3.

FIG. 5 is a schematic structural diagram of a second conductive portion after expansion according to an embodiment of this application.

FIG. 6 is a schematic enlarged diagram of an N region in FIG. 5.

FIG. 7 is a schematic sectional diagram of a battery in a third direction Y according to an embodiment of this application.

### REFERENCE NUMERALS

Electronic device—1; Battery—10; Housing—11; Separator—12; Electrode assembly—100; First conductive portion—110; First region—111; Second region—112; Third region—113; First surface—1101; Second surface—1201; Fourth region—114; Fifth region—115; Sixth region—116; Seventh region—117; Eighth region—118; First end—140; Second end—141; Third end—142; Fourth end—143; Fifth end—144; Sixth end—145; Seventh end—146; Eighth end—147; Ninth end—148; Tenth end—149; First side—160; Second side—161; Third side—162; Fourth side—163; Fifth side—164; Sixth side—165; Seventh side—166; Eighth side—167; Ninth side—168; Tenth side—169; First distance—A; Second distance—B; Third distance—C; Fourth distance—D; Fifth distance—E; Sixth distance—F; Seventh distance—G; Eighth distance—H; Ninth distance—I; Tenth distance—J; Eleventh distance—K; Twelfth distance—L; Second conductive portion—120; First metal portion—130; and Second metal portion—150.

### DETAILED DESCRIPTION

The following will clearly describe technical solutions in embodiments of this application in detail. Obviously, the described embodiments are only part of the embodiments of this application, not all of the embodiments. Unless otherwise defined, all technical and scientific terms used herein have the same meaning as those generally understood by those skilled in the technical field of this application. The terms used in the description of this application are for the purpose of describing specific embodiments only and are not intended to limit this application.

Hereinafter, embodiments of this application will be described in detail. However, this application may be embodied in many different forms and shall not be construed as limited to exemplary embodiments illustrated herein. Instead, these exemplary embodiments are provided so that this application is communicated thoroughly and in detail to those skilled in the art.

In addition, for simplicity and clarity, dimensions or thicknesses of various assemblies and layers may be enlarged in the accompanying drawings. Throughout the full text, the same values refer to the same elements. As used herein, the term “and/or” includes any and all combinations of one or more related enumerated items. In addition, it is to be understood that when element A is referred to as being “connected” with element B, element A may be directly connected with element B, or there may be an intermediate element C and elements A and B may be indirectly connected with each other.

Further, the use of “may” when describing the embodiments of this application means “one or more embodiments of this application”.

The technical terms used herein are for the purpose of describing specific embodiments and are not intended to limit this application. As used herein, the singular form is intended to include the plural form as well, unless the context explicitly states otherwise. It is to be further understood that the term “include”, when used in the description, refers to the presence of described features, values, steps, operations, elements and/or components, but does not exclude the presence or addition of one or more other features, values, steps, operations, elements, components and/or combinations thereof.

Spatially related terms, such as “above”, may be used for ease of describing the relationship between one element or feature and the other element(s) or feature(s) as illustrated in the figure. It is to be understood that in addition to the direction described in the figure, the spatially related terms are intended to include different directions of the equipment or device in use or operation. For example, if the equipment in the figure is turned over, the element described as being “above” or “over” the other element or feature will be directed “below” or “under” the other element or feature. Therefore, the exemplary term “above” may include both the above and below directions. It is to be understood that although terms of first, second, third and the like may be used herein to describe various elements, components, regions, layers and/or parts, such elements, components, regions, layers and/or parts shall not be limited to these terms. These terms are used to distinguish one element, component, region, layer or part from another element, component, region, layer or part. Therefore, the first element, component, region, layer or part discussed below may be referred to as the second element, component, region, layer or part without departing from the guidance of the exemplary embodiments. In this application, the first direction may be any direction in the plane on which the first surface is located.

The following will illustrate some embodiments of this application in detail. Where there is no conflict, the following embodiments and the features in the embodiments may be mutually combined.

In a related technology, when a battery is stored at a high temperature and after the battery is excessively used, due to aggravation of a chemical side reaction inside the battery, more gas will be generated inside the battery, resulting in an adverse impact on product performance, etc. of the battery due to excessively high internal gas pressure.

An objective of embodiments of this application is to provide an electrode assembly 100, a battery 10 and an electronic device 1 to advantageously reduce the probability of thermal failure of the battery 10 and improve safety of the battery 10.

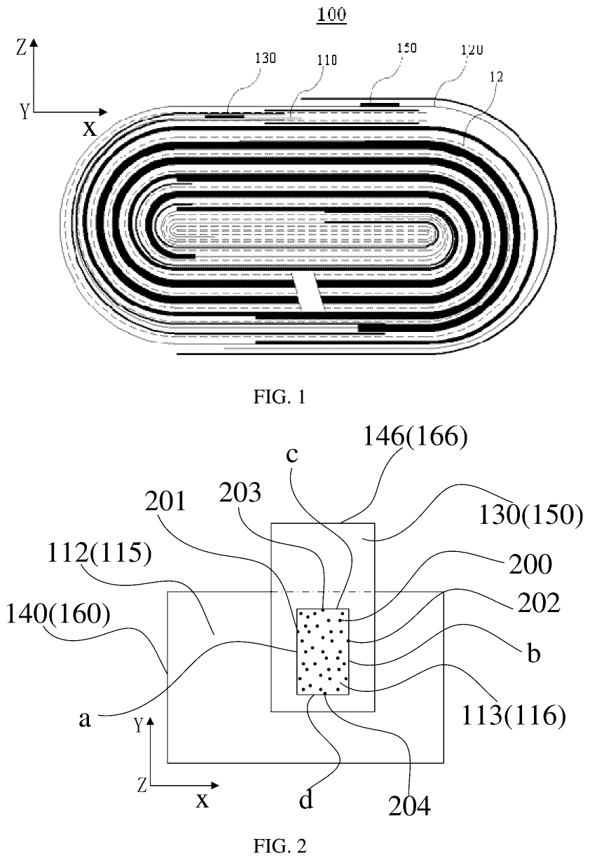

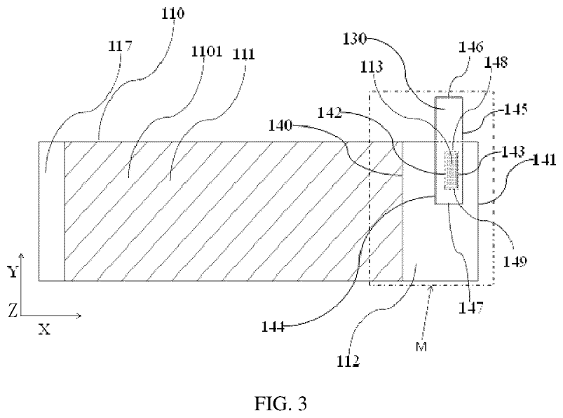

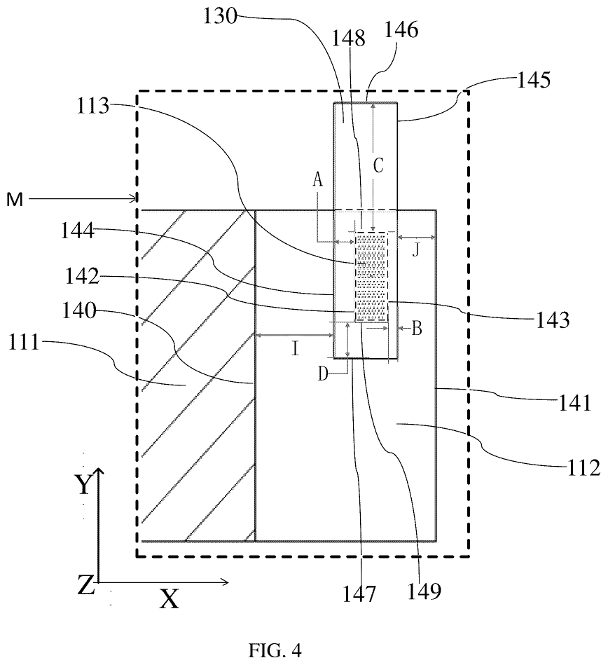

As shown in FIG. 1, FIG. 3 and FIG. 4, a first aspect of this application provides a wound electrode assembly 100, including a first conductive portion 110, a second conductive portion 120 and a first metal portion 130. The first conductive portion 110 includes a first region 111 provided with a conductive material layer and a second region 112 separated from the first region 111. The first metal portion 130 is connected with the second region 112 in a welded manner, and the first metal portion 130 is provided with a third region 113 where a weld mark is formed. When being observed in a first direction perpendicular to a first surface 1101 of the first conductive portion 110, the second region 112 is provided with a first end 140 in a second direction perpendicular to the first direction and extending from the first region 111 to the second region 112, and a second end 141 disposed on an opposite side of the first end 140 in the second direction and farther from the conductive material layer than the first end 140. The third region 113 is provided with a third end 142 in the second direction, and a fourth end 143 disposed on an opposite side of the third end 142 in the second direction and closer to the second end 141 than the third end 142. The first metal portion 130 is provided with a fifth end 144 in the second direction, and a sixth end 145 disposed on an opposite side of the fifth end 144 in the second direction and closer to the second end 141 than the fifth end 144. In the second direction, a first distance A between the third end 142 and the fifth end 144 is not equal to a second distance B between the fourth end 143 and the sixth end 145.

According to an embodiment of this application, the first conductive portion 110 and the second conductive portion 120 of the electrode assembly 100 may each be a positive electrode plate or a negative electrode plate, and the first conductive portion 110 and the second conductive portion 120 have opposite polarities. In other words, the first conductive portion 110 may serve as the positive electrode plate and may also serve as the negative electrode plate, and correspondingly, the second conductive portion 120 may serve as the negative electrode plate and may also serve as the positive electrode plate, which is not limited in this application. Further, as shown in FIG. 2, the electrode assembly 100 may further include a separator 12. The separator 12 is located between the first conductive portion 110 and the second conductive portion 120. The separator 12 is configured to separate the first conductive portion 110 from the second conductive portion 120 to prevent an internal short circuit between the first conductive portion 110 and the second conductive portion 120, and allow electrolytic ions to freely pass to form a conductive path. The first conductive portion 110 and the second conductive portion 120 may form the electrode assembly 100 in various ways, such as a wound electrode assembly 100, as shown in FIG. 1, which is not limited in the embodiment of this application, either. In some embodiments, as shown in FIG. 1, the electrode assembly 100 may further include the separator 12, and the separator 12 is located between the first conductive portion 110 and the second conductive portion 120.

In the embodiment of this application, the first direction may be a direction perpendicular to the first surface 1101 of the first conductive portion 110. The second direction may be a direction extending from the first region 110 of the first conductive portion 110 to the second region 112. The third direction is perpendicular to the first direction and the second direction, respectively. That is, as shown in FIG. 1 and FIG. 2, the first direction is a Z-axis direction shown in the figure, the second direction is an X-axis direction shown in the figure, and the third direction is a Y-axis direction shown in the figure.

In the embodiment of this application, the first metal portion 130 is a conductive portion leading out an electrode of the first conductive portion 110. The first metal portion 130 may serve as a positive electrode tab or a negative electrode tab. When the first metal portion 130 serves as the positive electrode tab, a material of the first metal portion 130 may include at least one of aluminum (Al) or an aluminum alloy, and when the first metal portion 130 serves as the negative electrode tab, the material of the first metal portion 130 may include at least one of nickel (Ni), copper (Cu) or nickel-plated copper (Ni—Cu).

The separator 12 may be a porous plastic film, and frequently-used materials of the separator 12 include polypropylene (PP), polyethylene (PE), a propylene-ethylene copolymer, a polyethylene homopolymer, etc.

In the electrode assembly 100 provided by the embodiment of this application, the first metal portion 130 is connected with the first conductive portion 110 in a welded manner, and the third region 113 is provided at a weld position of the first metal portion 130 and the first conductive portion 110 and internally provided with the weld mark. The third region 113 is located on the first conductive portion 110 and refers to a region of a weld zone formed by welding of the first conductive portion 110 and the first metal portion 130. The third region 113 may have an irregular shape and may also have a polygonal shape, such as a quadrangle, a pentagon, etc. In the embodiment of this application, in order to facilitate understanding, the third region 113 is rectangular. As shown in FIG. 2, it is a schematic structural diagram of the third region 113 formed by welding of the second region 112 of the first conductive portion 110 and the first metal portion 130. There are a plurality of weld spots 200 at different positions included in the weld zone. In the second direction X, there are a weld spot 201 nearest to the first end 140 and a weld spot 202 farthest from the first end 140, and two straight lines a and b parallel to the first end 140 are formed by passing through the weld spot 201 and the weld spot 202, respectively. In the third direction Y, there are a weld spot 203 nearest to a seventh end 146 and a weld spot 204 farthest from the seventh end 146, and two straight lines c and d parallel to the seventh end 146 are formed by passing through the weld spot 203 and the weld spot 204, respectively. The straight line a, the straight line b, the straight line c and the straight line d may be connected to from the above-mentioned third region 113.

In the direction from the first region 111 to the second region 112, there is the first distance A between the third end 142 of the third region 113 and the fifth end 144 of the first metal portion 130, there is the second distance B between the fourth end 143 of the third region 113 and the sixth end 145 of the first metal portion 130, and the first distance A is not equal to the second distance B. In other words, in the direction from the first region 111 to the second region 112, the third region 113 provided with the weld mark is not located in the middle of the first metal portion 130, that is, the weld mark is not located in the middle of the first metal portion 130. Therefore, after the first metal portion 130 is welded on the first conductive portion 110, welding residual stress is dispersed on the side of the fifth end 144 and the side of the sixth end 145 of the first metal portion 130 at different speeds, so that the welding residual stress tends be concentrated on the side of the third region 113 closer to the first metal portion 130. Therefore, when internal heat of the battery 10 is relatively high, side reactions between an electrolyte and a positive or negative electrode may increase, which in turn generates more gas, leading to an increase in internal gas pressure. The relatively high gas pressure can impact and disconnect the side of the third region 113 closer to the first metal portion 130, thereby disconnecting the first metal portion 130 from the first conductive portion 110 and realizing an open circuit of the battery 10, which is conducive to reducing the probability of thermal failure of the battery 10, and improving product performance of the battery 10.

As shown in FIG. 3 and FIG. 4, in some embodiments of this application, the first distance A is greater than the second distance B.

The first distance A refers to a straight length between the third end 142 of the third region 113 and the fifth end 144 of the first metal portion 130 in the second direction. In this way, the welding residual stress more tends to be concentrated on a side of the first metal portion 130 closer to the sixth end 145. Therefore, when the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the first metal portion 130 closer to the sixth end 145, thereby disconnecting the first metal portion 130 from the first conductive portion 110 and realizing the open circuit of the battery 10, which is conducive to reducing the probability of thermal failure of the battery 10, and improving the product performance of the battery 10.

In some other embodiments of this application, the first distance A is less than the second distance B. In this way, the welding residual stress more tends to be concentrated on a side of the first metal portion 130 closer to the fifth end 144. Therefore, when the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the first metal portion 130 closer to the fifth end 144, thereby disconnecting the first metal portion 130 from the first conductive portion 110 and realizing the open circuit of the battery 10, which is conducive to reducing the probability of thermal failure of the battery 10, and improving the product performance of the battery 10.

As shown in FIG. 3 and FIG. 4, in some embodiments of this application, the first metal portion 130 is provided with a seventh end 146 separated from the second region 112 in the third direction perpendicular to the second direction, and an eighth end 147 disposed on an opposite side of the seventh end 146 in the third direction. When being observed in the first direction, the third region 113 includes a ninth end 148 in the third direction, and a tenth end 149 disposed on an opposite side of the ninth end 148 in the third direction and closer to the eighth end 147 than the ninth end 148. In the third direction, a third distance C between the ninth end 148 and the seventh end 146 is not equal to a fourth distance D between the tenth end 149 and the eighth end 147.

In the embodiment of this application, in the third direction, the third region 113 provided with the weld mark is also not located in the middle of the first metal portion 130. Therefore, after the first metal portion 130 is welded on the first conductive portion 110, the welding residual stress is dispersed on the side of the seventh end 146 and the side of the eighth end 147 of the first metal portion 130 at different speeds, and the welding residual stress tends to be concentrated on the side of the third region 113 closer to the first metal portion 130 in the second direction and the side of the third region 113 closer to the first metal portion 130 in the third direction.

In the embodiment of this application, the magnitude relationship between the third distance C and the fourth distance D may be flexibly combined with the foregoing magnitude relationship between the first distance A and the second distance B, thereby flexibly adjusting a position of a region on the first metal portion 130 where the welding residual stress tends to be concentrated.

For example, when A is greater than B and C is greater than D, the welding residual stress tends to be concentrated in an intersection region of two sides of the first metal portion 130 close to the sixth end 145 and the eighth end 147. When the internal heat of the battery 10 is relatively high, the side reactions between the electrolyte and the positive or negative electrode may increase, which in turn generates more gas, leading to the increase in internal gas pressure. Moreover, when the internal gas pressure is relatively high, the relatively high gas pressure can impact and disconnect the intersection region of the two sides of the first metal portion 130 close to the sixth end 145 and the eighth end 147, thereby disconnecting the first metal portion 130 from the first conductive portion 110 and realizing the open circuit of the battery 10, which is conducive to reducing the probability of thermal failure of the battery 10, and improving the product performance of the battery 10.

Certainly, it is easy to understand that if A is greater than B and C is less than D, the welding residual stress tends to be concentrated in an intersection region of two sides of the first metal portion 130 close to the sixth end 145 and the seventh end 146. Those skilled in the art may set their own according to demands.

Further, as shown in FIG. 3 and FIG. 4, the third distance C is greater than the fourth distance D. In this way, in the third direction, the welding residual stress tends to be concentrated on a side of the first metal portion 130 close to the eighth end 147. Therefore, when the internal heat of the battery 10 is relatively high, the side reactions between the electrolyte and the positive or negative electrode may increase, which in turn generates more gas, leading to the increase in internal gas pressure. The relatively high gas pressure tends to impact and disconnect the side of the first metal portion 130 close to the eighth end 147, thereby disconnecting the first metal portion 130 from the first conductive portion 110 and realizing the open circuit of the battery 10, which is conducive to reducing the probability of thermal failure of the battery 10, and improving the product performance of the battery 10.

Alternatively, in some other embodiments of this application, the third distance C is less than the fourth distance D. In this way, in the third direction, the welding residual stress tends to be concentrated on a side of the first metal portion 130 close to the seventh end 146. When the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the first metal portion 130 close to the seventh end 146, thereby disconnecting the first metal portion 130 from the first conductive portion 110 and realizing the open circuit of the battery 10, which is conducive to reducing the probability of thermal failure of the battery 10, and improving the product performance of the battery 10.

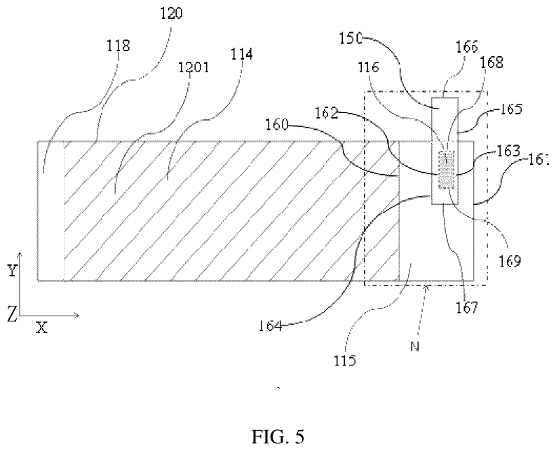

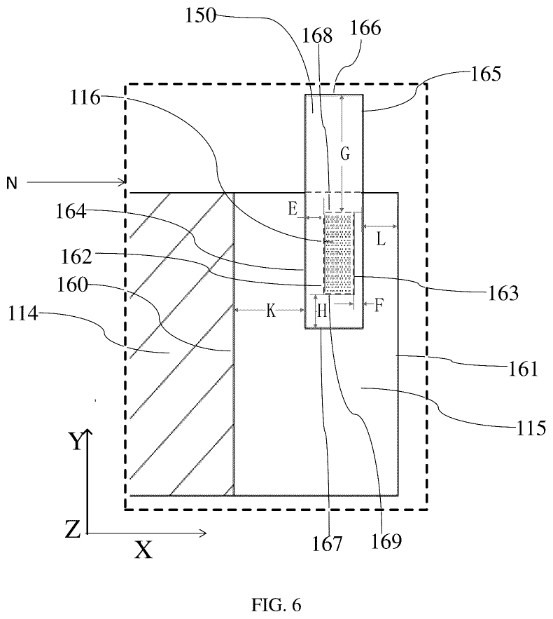

In some embodiments of this application, as shown in FIG. 1, FIG. 5 and FIG. 6, the second conductive portion 120 includes a fourth region 114 provided with a conductive material layer, and a fifth region 115 separated from the fourth region 114. The electrode assembly 100 further includes a second metal portion 150, the second metal portion 150 is connected with the fifth region 115 in a welded manner, and the second metal portion 150 includes a sixth region 116 provided with a weld mark. When being observed in the first direction perpendicular to a second surface 1201 of the second conductive portion 120, the fifth region 115 is provided with a first side 160 in the second direction, and a second side 161 disposed on an opposite side of the first side 160 in the second direction and farther from the conductive material layer than the first side 160. The sixth region 116 is provided with a third side 162 in the second direction, and a fourth side 163 disposed on an opposite side of the third side 162 in the second direction and closer to the second side 161 than the third side 162. The second metal portion 150 is provided with a fifth side 164 in the second direction, and a sixth side 165 disposed on an opposite side of the fifth side 164 in the second direction and closer to the second side 161 than the fifth side 164. In the second direction, a fifth distance E between the third side 162 and the fifth side 164 is not equal to a sixth distance F between the fourth side 163 and the sixth side 165.

The electrode assembly 100 provided by the embodiment of this application is further provided with the second conductive portion 120 and the second metal portion 150. The second metal portion 150 is a conductive portion leading out an electrode of the second conductive portion 120. The second metal portion 150 may serve as a positive electrode tab or a negative electrode tab, and the second metal portion 150 and the first metal portion 130 have opposite polarities. A material of the second metal portion 150 may refer to a relevant description of the material of the first metal portion 130, which is not described in detail herein.

In the embodiment of this application, the second metal portion 150 is welded to the second conductive portion 120, and the sixth region 116 is provided at a weld position of the second metal portion 150 and the second conductive portion 120 and internally provided with the weld mark. The sixth region 116 is located on the second conductive portion 120 and refers to a region of a weld zone formed by welding of the second conductive portion 120 and the second metal portion 150. The sixth region 116 may have an irregular shape and may also have a polygonal shape, such as a quadrangle, a pentagon, etc. In the embodiment of this application, in order to facilitate understanding, the sixth region 116 is rectangular. As shown in FIG. 2, it is a schematic structural diagram of the sixth region 116 formed by welding of the fifth region 115 of the second conductive portion 120 and the second metal portion 150. There are a plurality of weld spots 200 at different positions included in the weld zone. In the second direction X, there are a weld spot 201 nearest to the first side 160 and a weld spot 202 farthest from the first side 160, and two straight lines a and b parallel to the first side 160 are formed by passing through the weld spot 201 and the weld spot 202, respectively. In the third direction Y, there are a weld spot 203 nearest to the seventh side 166 and a weld spot 204 farthest from the seventh side 166, and two straight lines c and d parallel to the seventh side 166 are formed by passing through the weld spot 203 and the weld spot 204, respectively. The straight line a, the straight line b, the straight line c and the straight line d are connected to from the above-mentioned sixth region 116.

The second conductive portion 120 includes the fourth region 114 and the fifth region 115. In the direction from the fourth region 114 to the fifth region 115, there is the fifth distance E between the third side 162 of the sixth region 116 and the fifth side 164 of the second metal portion 150, there is the sixth distance F between the fourth side 163 of the sixth region 116 and the sixth side 165 of the second metal portion 150, and the fifth distance E is not equal to the sixth distance F. In other words, in the direction from the fourth region 114 to the fifth region 115, the sixth region 116 provided with the weld mark is not located in the middle of the second metal portion 150. Therefore, after the second metal portion 150 is welded on the second conductive portion 120, the welding residual stress is dispersed on the fifth side 164 and the sixth side 165 of the second metal portion 150 at different speeds, so that the welding residual stress tends be concentrated on a side of the sixth region 116 closer to the second metal portion 150. When the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the sixth region 116 closer to the second metal portion 150, thereby disconnecting the second metal portion 150 from the second conductive portion 120 and realizing the open circuit of the battery 10, which is conducive to reducing the probability of thermal failure of the battery 10, and improving the product performance of the battery 10.

In some embodiments of this application, as shown in FIG. 5 and FIG. 6, the fifth distance E is greater than the sixth distance F. In this way, the welding residual stress tends to be concentrated on a side of the second metal portion 150 close to the sixth side 165. When the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the second metal portion 150 close to the sixth side 165, thereby disconnecting the second metal portion 150 from the second conductive portion 120 and realizing the open circuit of the battery 10, which is conducive to reducing the probability of thermal failure of the battery 10, and improving the product performance of the battery 10.

In some other embodiments of this application, the fifth distance E is less than the sixth distance F. In this way, the welding residual stress tends to be concentrated on a side of the second metal portion 150 close to the fifth side 164. When the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the second metal portion 150 close to the fifth side 164, thereby disconnecting the second metal portion 150 from the second conductive portion 120 and realizing the open circuit of the battery 10, which is conducive to reducing the probability of thermal failure of the battery 10, and improving the product performance of the battery 10.

In some embodiments of this application, the second metal portion 150 is provided with a seventh side 166 separated from the fifth region 115 in the third direction perpendicular to the second direction, and an eighth side 167 disposed on an opposite side of the seventh side 166 in the third direction. When being observed in the first direction, the sixth region 116 is provided with a ninth side 168 in the third direction and a tenth side 169 disposed on an opposite side of the ninth side 168 in the third direction and closer to the eighth side 167 than the ninth side 168. In the third direction, a seventh distance G between the ninth side 168 and the seventh side 166 is not equal to an eighth distance H between the tenth side 169 and the eighth side 167.

In the embodiment of this application, in the third direction, the sixth region 116 provided with the weld mark is not located in the middle of the second metal portion 150. Therefore, after the second metal portion 150 is welded on the second conductive portion 120, the welding residual stress is dispersed on the seventh side 166 and the eighth side 167 of the second metal portion 150 at different speeds, and the welding residual stress tends be concentrated on a side of the sixth region 116 closer to the second metal portion 150 in the second direction and a side of the sixth region 116 closer to the second metal portion 150 in the third direction. When the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the sixth region 116 closer to the second metal portion 150 in the second direction and the side of the sixth region 116 closer to the second metal portion 150 in the third direction, thereby disconnecting the second metal portion 150 from the second conductive portion 120 and realizing the open circuit of the battery 10, which is conducive to reducing the probability of thermal failure of the battery 10, and improving the product performance of the battery 10.

Similarly, the magnitude relationship between the fifth distance E and the sixth distance F and the magnitude relationship between the seventh distance G and the eighth distance H formed by the second conductive portion 120 and the second metal portion 150 may also be flexibly combined, thereby flexibly adjusting a position of a part on the second metal portion 150 where the welding residual stress tends to be concentrated.

Further, as shown in FIG. 5 and FIG. 6, the seventh distance is greater than the eighth distance H. In this way, in the third direction, the welding residual stress tends to be concentrated on a side of the second metal portion 150 close to the eighth side 167. When the internal heat of the battery 10 is relatively high, the side reactions between the electrolyte and the positive or negative electrode may increase, which in turn generates more gas, leading to the increase in internal gas pressure. The relatively high gas pressure tends to impact and disconnect the side of the second metal portion 150 close to the eighth side 167, thereby disconnecting the second metal portion 150 from the second conductive portion 120 and realizing the open circuit of the battery 10, which is conducive to reducing the probability of thermal failure of the battery 10, and improving the product performance of the battery 10.

Alternatively, in some other embodiments of this application, the seventh distance G is less than the eighth distance H. In this way, in the third direction, the welding residual stress tends to be concentrated on a side of the second metal portion 150 close to the seventh side 166. When the internal heat of the battery 10 is relatively high, the side reactions between the electrolyte and the positive or negative electrode may increase, which in turn generates more gas, leading to the increase in internal gas pressure. The relatively high gas pressure tends to impact and disconnect the side of the second metal portion 150 close to the seventh side 166, thereby disconnecting the second metal portion 150 from the second conductive portion 120 and realizing the open circuit of the battery 10, which is conducive to reducing the probability of thermal failure of the battery 10, and improving the product performance of the battery 10.

In some embodiments of this application, as shown in FIG. 3 and FIG. 4, in the second direction, a ninth distance I between the first end 140 and the fifth end 144 is greater than a tenth distance J between the second end 141 and the sixth end 145. In this way, the welding residual stress on the first metal portion 130 tends to be concentrated on a side of the first metal portion 130 close to the second end 141. When the internal heat of the battery 10 is relatively high, the side reactions between the electrolyte and the positive or negative electrode may increase, which in turn generates more gas, leading to the increase in internal gas pressure. The relatively high gas pressure tends to impact and disconnect the side of the first metal portion 130 close to the second end 141, thereby disconnecting the first metal portion 130 from the first conductive portion 110 and realizing the open circuit of the battery 10, which is conducive to reducing the probability of thermal failure of the battery 10, and improving the product performance of the battery 10.

In some embodiments of this application, in the second direction, a distance between the first end 140 and the fifth end 144 ranges from 1 mm to 30 mm, and a distance between the second end 141 and the sixth end 145 ranges from 1 m to 20 mm. The first metal portion 130 is at a certain distance from both the first end 140 and the second end 141 of the first conductive portion 110, which is conducive to reducing the impact of the conductive material layer on the first metal portion 130 and also conducive to avoiding the impact on the first metal portion 130 when the first conductive portion 110 is manufactured, e.g., wound.

In some embodiments of this application, in the second direction, an eleventh distance K between the first side 160 and the fifth side 164 is less than a twelfth distance L between the second side 161 and the sixth side 165. The welding residual stress on the second metal portion 150 tends to be concentrated on a side of the second metal portion 150 close to the first side 160. When the internal heat of the battery 10 is relatively high, the side reactions between the electrolyte and the positive or negative electrode may increase, which in turn generates more gas, leading to the increase in internal gas pressure. The relatively high gas pressure tends to impact and disconnect the side of the second metal portion 150 close to the first side 160, thereby disconnecting the second metal portion 150 from the second conductive portion 120 and realizing the open circuit of the battery 10, which is conducive to reducing the probability of thermal failure of the battery 10, and improving the product performance of the battery 10.

In some embodiments of this application, in the second direction, a distance between the first side 160 and the fifth side 164 ranges from 1 mm to 30 mm, and a distance between the second side 161 and the sixth side 165 ranges from 1 m to 20 mm. The second metal portion 150 is at a certain distance from both the first side 160 and the second side 161 of the second conductive portion 120, which is conducive to reducing the impact of the conductive material layer on the second metal portion 150 and also conducive to avoiding the impact on the second metal portion 150 when the second conductive portion 120 is manufactured.

In some embodiments of this application, in the second direction, a distance between the first end 140 and the second end 141 ranges from 10 mm to 40 mm; and a distance between the first side 160 and the second side 161 ranges from 10 mm to 40 mm. Both the second region 112 and the fifth region 115 have enough space to accommodate the first metal portion 130 and the second metal portion 150, so as to reserve more welding space for the first metal portion 130 and the second metal portion 150, which is conducive to improving reliability of the battery 10.

In some embodiments of this application, as shown in FIG. 3, the first conductive portion 110 further includes a seventh region 117 separated from the first region 111, and the seventh region 117 is located on a side of the first region 111 away from the second region 112 in such a way that the first metal portion 130 may be not only selectively welded to the second region 112, but also selectively welded to the seventh region 117, so that the first metal portion 130 may be located at different positions of the first conductive portion 110, which is conducive to improving diversity of the electrode assembly 100.

In some embodiments of this application, as shown in FIG. 5, the second conductive portion 120 further includes an eighth region 118 separated from the fourth region 114, and the eighth region 118 is located on a side of the fourth region 114 away from the fifth region 115. In this way, the second metal portion 150 may be not only selectively welded to the fifth region 115, but also selectively welded to the eighth region 118, so that the second metal portion 150 may be located at different positions of the second conductive portion 120, which is conducive to improving the diversity of the electrode assembly 100.

In some embodiments of this application, the first conductive portion 110 serves as a positive electrode. The first metal portion 130 is connected with the positive electrode to serve as a positive electrode tab. At this time, the first metal portion 130 is configured to lead out a positive electrode current of the electrode assembly 100.

In some embodiments of this application, the second conductive portion 120 serves as a negative electrode. The second metal portion 150 is connected with the negative electrode to serve as a negative electrode tab. At this time, the second metal portion 150 is configured to lead out a negative electrode current of the electrode assembly 100.

In some embodiments of this application, the first conductive portion 110 is wound around a first axis and includes a plurality of layers of first regions 111 in the first direction, and the second conductive portion 120 is wound around the first axis and includes a plurality of layers of fourth regions 114 in the first direction. The first metal portion 130 is connected with an outermost first region 111 in the first direction. In this way, the first metal portion 130 is located on an outermost side of the electrode assembly 100, and the pressure on the outermost side is greater than the pressure on other parts of the electrode assembly 100, which is conducive to disconnecting the first metal portion 130 from the first conductive portion 110.

Alternatively, in some other embodiments of this application, the second conductive portion 150 is connected with an outermost fourth region 114 in the first direction. In this way, the second metal portion 150 is located on an outermost side of the electrode assembly 100, and the pressure on the outermost side is greater than the pressure on the other parts of the electrode assembly 100, which is conducive to disconnecting the second metal portion 150 from the second conductive portion 120.

Alternatively, in some other embodiments of this application, the first metal portion 130 is connected with the outermost first region 111 in the first direction, and the second metal portion 150 is connected with the outermost fourth region 114 in the first direction. In this way, both the first metal portion 130 and the second metal portion 150 are located on the outermost side of the electrode assembly 100, and the pressure on the outermost side is greater than the pressure on the other parts of the electrode assembly 100, which is conducive to disconnecting the first metal portion 130 from the first conductive portion 110 or disconnecting the second metal portion 150 from the second conductive portion 120.

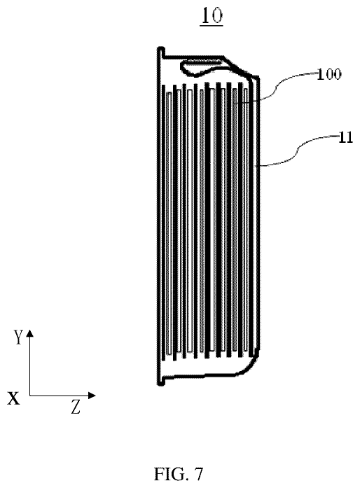

A second aspect of this application provides a battery 10. As shown in FIG. 7, it is a schematic sectional diagram of the battery 10 dissected in a YZ-plane and observed in an X direction. The battery 10 includes a housing 11 and the above-mentioned electrode assembly 100, and the electrode assembly 100 is placed in the housing 11.

The housing 11 may be a square housing and may also be a cylindrical housing, which is not limited in an embodiment of this application.

According to the battery 10 provided by the embodiment of this application, by improving the electrode assembly 100 in the battery 10, the product performance of the battery 10 is advantageously improved. The electrode assembly 100 includes the first conductive portion 110, the second conductive portion 120 and the first metal portion 130. The first metal portion 130 of the electrode assembly 100 is welded to the first conductive portion 110, and the third region 113 is provided at the weld position of the first metal portion 130 and the first conductive portion 110 and internally provided with the weld mark. In the direction from the first region 111 to the second region 112, there is the first distance A between the third end 142 of the third region 113 and the fifth end 144 of the first metal portion 130, there is the second distance B between the fourth end 143 of the third region 113 and the sixth end 145 of the first metal portion 130, and the first distance A is not equal to the second distance B. In other words, in the direction from the first region 111 to the second region 112, the third region 113 provided with the weld mark is not located in the middle of the first metal portion 130, that is, the weld mark is not located in the middle of the first metal portion 130. Therefore, after the first metal portion 130 is welded on the first conductive portion 110, the welding residual stress is dispersed on the side of the fifth end 144 and the side of the sixth end 145 of the first metal portion 130 at different speeds, and the welding residual stress tends to be concentrated on the side of the third region 113 closer to the first metal portion 130. Therefore, when the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the third region 113 closer to the first metal portion 130, thereby disconnecting the first metal portion 130 from the first conductive portion 110 and realizing the open circuit of the battery 10, which is conducive to reducing the probability of thermal failure of the battery 10, and improving the product performance of the battery 10.

In some embodiments of this application, a material of the housing 11 includes metal. The housing 11 of the metal material facilitates protection of the internal electrode assembly 100, which is conducive to improving the reliability of the battery 10. For example, the material of the housing 11 is aluminum, iron, an aluminum alloy, etc., which is not limited in the embodiments of this application.

In some embodiments of this application, the battery 10 is a wound battery.

Specifically, a plurality of embodiments and comparative embodiments are given to more specifically illustrate the above disclosed embodiments. Various batteries composed of different electrode assemblies 100 are selected for various experiments, and experimental results are shown in Table 1.

TABLE 1
Impact of weld mark position on product performance of battery

| | | Comparative | Embodiment | Embodiment |
|---|---|---|---|---|
| | Battery size | embodiment | 1 | 2 |
| Size | Electrode tab | 2.0 | 2.0 | 2.0 |
| unit mm | width | | | |
| | Electrode tab | 22.0 | 25.0 | 24.0 |
| | length | | | |
| | Weld mark width | 1.4 | 1.4 | 1.4 |
| | Weld mark | 6.0 | 8.0 | 8.0 |
| | length | | | |
| | A | 0.3 | 0.4 | 0.4 |
| | B | 0.3 | 0.2 | 0.2 |
| | C | 8.0 | 12.0 | 8.0 |
| | D | 8.0 | 5.0 | 8.0 |
| Experi- | High- | 8/20 | 20/20 | 20/20 |
| mental | temperature | | | |
| result | storage pass rate | | | |
| | High- | 7/20 | 20/20 | 18/20 |
| | temperature | | | |
| | cycling pass rate | | | |
| | Overcharge pass | 0/20 | 20/20 | 20/20 |
| | rate | | | |

In Table 1, a high-temperature storage test means that a battery is fully charged into a 100% SOC and stored in a 85° C. environment for seven days. A high-temperature cycling test means that at an environment temperature of 60° C., the battery is charged and discharged from zero charge to full charge for 300 cycles, with a charge rate of 1.3 C and a discharge rate of 1 C, where the charge rate of 1.3 C means that the battery can be charged 1.3 times within one hour, and the discharge rate of 1 C refers to that it takes one hour to complete a discharge. An overcharge test means that the battery is charged with a constant charge current of three times a rated battery current, and charged until a battery voltage reaches 5 V, then the constant current is reduced to 0.05 times the rated battery current for continuous charging.

A pass rate refers to a ratio of the number of batteries without thermal failure to the total number of the tested batteries during or after a test, rather than a ratio of the number of batteries that still have intact functions after the test to the total number of the tested batteries. For example, in the high-temperature cycling test, a pass rate of the comparative embodiment is 7/20, which indicates that 13 of 20 batteries undergo thermal failure during the test; and a pass rate of Embodiment 1 is 20/20, which indicates that none of the 20 batteries adopting the embodiment of this application undergo thermal failure during the test. It does not mean that all the batteries still have the intact functions after the test. In other words, after the test, part or even all of the 20 batteries according to the embodiment of this application are avoided from thermal failure by disconnecting the first conductive portion from the first metal portion or disconnecting the second conductive par from the second metal portion, and no longer have the intact functions.

In the battery size, an electrode tab refers to the first metal portion 130 or the second metal portion 150 in the electrode assembly 100 according to the embodiment of this application. A, B, C and D refer to the first distance, the second distance, the third distance and the fourth distance in the embodiment of this application, respectively.

In Comparative embodiment 1, A is equal to B and C is equal to D, that is, the weld mark, i.e., the third region 113 is located in the middle of the first metal portion 130 in both the second direction and the third direction. In this way, the welding residual stress is dispersed on the two sides of the first metal portion 130 at the same speed. The experimental results show that the batteries undergo thermal failure in each of the high-temperature storage, high-temperature cycling and overcharge pass rate tests, which is not conducive to improving the product performance of the batteries.

In Embodiment 1, A is greater than B and C is greater than D, that is, as shown in FIG. 1, the weld mark, i.e., the third region 113 is not located in the middle of the first metal portion 130 in both the second direction and the third direction. Compared with Comparative embodiment 1, it shows that in the high-temperature storage, high-temperature cycling and overcharge pass rate tests, the batteries in Embodiment 1 do not undergo thermal failure, and the probability of thermal failure of the batteries is advantageously reduced by disconnecting the first metal portion 130 from the first conductive portion 110. In other words, in Embodiment 1, the welding residual stress tends to be concentrated in the intersection region of the two sides of the first metal portion 130 close to the sixth end 145 and the eighth end 147. When the internal heat of the battery 10 is relatively high, the side reactions between the electrolyte and the positive or negative electrode may increase, which in turn generates more gas, leading to the increase in internal gas pressure. The relatively high gas pressure can impact and disconnect the intersection region of the two sides of the first metal portion 130 close to the sixth end 145 and the eighth end 147, thereby disconnecting the first metal portion 130 from the first conductive portion 110 and realizing the open circuit of the battery 10, which is conducive to reducing the probability of thermal failure of the battery 10, and improving the product performance of the battery 10.

In Embodiment 2, A is greater than B and C is equal to D, that is, the third region 113 is not located in the middle of the first metal portion 130 in the second direction and is located in the middle of the first metal portion 130 in the third direction. Compared with Comparative embodiment 1, it shows that in the high-temperature cycling pass rate test, a pass rate of Comparative embodiment 1 is 7/20, a pass rate of Embodiment 2 is 8/20, and Embodiment 2 has a lower probability of thermal failure of the batteries than Comparative embodiment 1, and the probability of thermal failure of the batteries is advantageously reduced by disconnecting the first metal portion 130 from the first conductive portion 110. In other words, in Embodiment 2, the welding residual stress tends to be concentrated on the side of the first metal portion 130 close to the sixth end 145. When the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the first metal portion 130 close to the sixth end 145, thereby disconnecting the first metal portion 130 from the first conductive portion 110 and realizing the open circuit of the battery 10, which is conducive to reducing the probability of thermal failure of the battery 10, and improving the product performance of the battery 10.

A third aspect of this application provides an electronic device 1, including the above-mentioned battery 10.

The electronic device may, but is not limited to, be an electric vehicle, a mobile phone, a notebook computer, an electric toy, an electric tool, a battery vehicle, etc. using the battery 10 according to the embodiment of this application in the second aspect as a power supply.

According to the electronic device 1 provided by the embodiment of this application, by improving the electrode assembly 100 of the battery 10 in the electronic device 1, the product performance of the electronic device 1 is advantageously improved. The electrode assembly 100 includes the first conductive portion 110, the second conductive portion 120 and the first metal portion 130. The first metal portion 130 of the electrode assembly 100 is welded to the first conductive portion 110, and the third region 113 is provided at the weld position of the first metal portion 130 and the first conductive portion 110 and internally provided with the weld mark. In the direction from the first region 111 to the second region 112, there is the first distance A between the third end 142 of the third region 113 and the fifth end 144 of the first metal portion 130, there is the second distance B between the fourth end 143 of the third region 113 and the sixth end 145 of the first metal portion 130, and the first distance A is not equal to the second distance B. In other words, in the direction from the first region 111 to the second region 112, the third region 113 provided with the weld mark is not located in the middle of the first metal portion 130, that is, the weld mark is not located in the middle of the first metal portion 130. Therefore, after the first metal portion 130 is welded on the first conductive portion 110, the welding residual stress is dispersed on the side of the fifth end 144 and the side of the sixth end 145 of the first metal portion 130 at different speeds, and the welding residual stress tends to be concentrated on the side of the third region 113 closer to the first metal portion 130. Therefore, when the internal heat of the battery 10 is relatively high, the side reactions between the electrolyte and the positive or negative electrode may increase, which in turn generates more gas, leading to the increase in internal gas pressure. The relatively high gas pressure can impact and disconnect the side of the third region 113 closer to the first metal portion 130, thereby disconnecting the first metal portion 130 from the first conductive portion 110 and realizing the open circuit of the battery 10, which is conducive to reducing the probability of thermal failure of the battery 10, and improving the product performance of the electronic device 1.

The foregoing are only preferred embodiments of this application and are not intended to limit this application, and any modifications, equivalent replacements, improvements, and the like made within the principles of this application shall be encompassed within the scope of protection of this application.

What is claimed is:

1. An electrode assembly, comprising a first conductive portion, a second conductive portion and a first metal portion; wherein
the first conductive portion comprises a first region provided with a conductive material layer and a second region separated from the first region;
the first metal portion is connected with the second region by welding, and the first metal portion comprises a third region provided with a weld mark;
when being observed in a first direction perpendicular to a first surface of the first conductive portion, the second region is provided with a first end in a second direction perpendicular to the first direction and extending from the first region to the second region, and a second end disposed on an opposite side to the first end in the second direction and farther from the conductive material layer than the first end;
the third region is provided with a third end in the second direction, and a fourth end disposed opposite side to the third end in the second direction and closer to the second end than the third end;
the first metal portion is provided with a fifth end in the second direction, and a sixth end disposed opposite to the fifth end in the second direction and closer to the second end than the fifth end; and
in the second direction, a first distance between the third end and the fifth end is not equal to a second distance between the fourth end and the sixth end.

2. The electrode assembly according to claim 1, wherein the first distance is less than the second distance.

3. The electrode assembly according to claim 2, wherein
the first metal portion is provided with a seventh end separated from the second region in a third direction perpendicular to the second direction, and an eighth end disposed opposite to the seventh end in the third direction;
when being observed in the first direction, the third region comprises a ninth end in the third direction, and a tenth end disposed opposite to the ninth end in the third direction and closer to the eighth end than the ninth end; and
in the third direction, a third distance between the ninth end and the seventh end is not equal to a fourth distance between the tenth end and the eighth end.

4. The electrode assembly according to claim 3, wherein the third distance is greater than the fourth distance.

5. The electrode assembly according to claim 1, wherein
the second conductive portion comprises a fourth region provided with a conductive material layer, and a fifth region separated from the fourth region;
the electrode assembly further comprises a second metal portion, the second metal portion being connected with the fifth region in a welded manner, and the second metal portion comprising a sixth region provided with a weld mark;
when being observed in the first direction perpendicular to a second surface of the second conductive portion, the fifth region is provided with a first side in the second direction, and a second side disposed opposite to the first side in the second direction and farther from the conductive material layer than the first side;
the sixth region is provided with a third side in the second direction, and a fourth side disposed opposite to the third side in the second direction and closer to the second side than the third side;
the second metal portion is provided with a fifth side in the second direction, and a sixth side disposed opposite to the fifth side in the second direction and closer to the second side than the fifth side; and
in the second direction, a fifth distance between the third side and the fifth side is not equal to a sixth distance between the fourth side and the sixth side.

6. The electrode assembly according to claim 5, wherein the fifth distance is greater than the sixth distance.

7. The electrode assembly according to claim 6, wherein
the second metal portion is provided with a seventh side separated from the fifth region in a third direction perpendicular to the second direction, and an eighth side disposed opposite to the seventh side in the third direction;
when being observed in the first direction, the sixth region is provided with a ninth side in the third direction, and a tenth side disposed opposite to the ninth side in the third direction and closer to the eighth side than the ninth side; and
in the third direction, a seventh distance between the ninth side and the seventh side is not equal to an eighth distance between the tenth side and the eighth side.

8. The electrode assembly according to claim 7, wherein the seventh distance is greater than the eighth distance.

9. The electrode assembly according to claim 1, wherein the electrode assembly satisfies at least one of the following conditions:
(1) in the second direction, a ninth distance between the first end and the fifth end is greater than a tenth distance between the second end and the sixth end; or
(2) in the second direction, a distance between the first end and the fifth end ranges from 1 mm to 30 mm, and a distance between the second end and the sixth end ranges from 1 mm to 20 mm.

10. The electrode assembly according to claim 5, wherein the electrode assembly satisfies at least one of the following conditions:
(1) in the second direction, a ninth distance between the first end and the fifth end is greater than a tenth distance between the second end and the sixth end; or
(2) in the second direction, a distance between the first end and the fifth end ranges from 1 mm to 30 mm, and a distance between the second end and the sixth end ranges from 1 mm to 20 mm.

11. The electrode assembly according to claim 5, wherein the electrode assembly satisfies at least one of the following conditions:
(1) in the second direction, an eleventh distance between the first side and the fifth side is less than a twelfth distance between the second side and the sixth side;
(2) in the second direction, a distance between the first side and the fifth side ranges from 1 mm to 30 mm, and a distance between the second side and the sixth side ranges from 1 mm to 20 mm; or
(3) in the second direction, a distance between the first end and the second end ranges from 10 mm to 40 mm, and a distance between the first side and the second side ranges from 10 mm to 40 mm.

12. The electrode assembly according to claim 1, wherein the first conductive portion further comprises a seventh region separated from the first region, and the seventh region is located on a side of the first region facing away from the second region.

13. The electrode assembly according to claim 5, wherein the first conductive portion further comprises a seventh region separated from the first region, and the seventh region is located on a side of the first region facing away from the second region.

14. The electrode assembly according to claim 5, wherein the second conductive portion further comprises an eighth region separated from the fourth region, and the eighth region is located on a side of the fourth region facing away from the fifth region.

15. The electrode assembly according to claim 1, wherein the electrode assembly satisfies one of the following conditions:
(1) the first conductive portion serves as a positive electrode;
(2) the second conductive portion serves as a negative electrode.

16. The electrode assembly according to claim 5, wherein the electrode assembly satisfies one of the following conditions:
(1) the first conductive portion serves as a positive electrode;
(2) the second conductive portion serves as a negative electrode.

17. The electrode assembly according to claim 5, wherein the first conductive portion is wound around a first axis and comprises a plurality of layers of first regions in the first direction, the second conductive portion is wound around the first axis and comprises a plurality of layers of fourth regions in the first direction; the first metal portion is connected with an outermost first region in the first direction, and/or the second metal portion is connected with an outermost fourth region in the first direction.

18. A battery, wherein the battery comprises a housing and the electrode assembly according to claim 1, and the electrode assembly is disposed in the housing.

19. The battery according to claim 18, wherein the battery satisfies at least one of the following conditions:
(1) a material of the housing comprises a metal;
(2) the battery is a wound battery.

20. An electronic device, wherein the electronic device comprises the battery according to claim 18.
